(19) United States
(12) Patent Application Publication
(10) Pub. No.: US 2008/0149192 A1
(43) Pub. Date: Jun. 26, 2008

(54) Valve

(76) Inventors: Henry V. Holec, Mendora Heights, MN (US); Douglas P. Goulet, Hanover, MN (US); Daniel W. Celotta, Circle Pines, MN (US); Stephen J. Czeck, Shoreview, MN (US); Richard Nighy, Stratford upon Avon (GB)

Correspondence Address: PYLE & PIONTEK LLC, 221 N. LASALLE STREET, SUITE 2036, CHICAGO, IL, 60601, US

(21) Appl. No.: 11/795,107

(22) PCT Filed: Jan. 12, 2006
(86) PCT No.: PCT/GB2006/000105

§ 371 Date: Jul. 11, 2007

(30) Foreign Application Priority Data
Jan. 13, 2005 (GB) 0500624.2
Jun. 4, 2005 (GB) 0511432.7
Jun. 4, 2005 (GB) 0511433.5
Jun. 4, 2005 (GB) 0511435.0
Jun. 4, 2005 (GB) 0511436.8
Jun. 4, 2005 (GB) 0511437.6

(51) Int. Cl. F16K 31/36

(52) U.S. Cl. 137/491

(57) ABSTRACT

A valve 100 comprising a magnetic circuit comprising a first member 101 and a pivotably mounted armature 102 the armature being movable between a position in which the valve seal 104 engages the valve seat 105 of valve port 103 to block the valve port 103, and a position away from the first member 101. A coil 106 surrounds the armature 102 which, when supplied with an electric current, creates a magnetic field in the armature 102 attracting the free end to the first member 101. Dampening pads 110 are provided on the armature 102. Each dampener pad 110 comprises a layer of viscoelastic material covered by a protective layer of polyetheretherketone (PEEK). During use, as there is wear between the armature 102 and the first member 101, and/or non magnetic section 107, the dampening pad 110 is compressed on impact by an increasing degree, thus the more worn the valve becomes, the more the dampening and thus the greater the protection against further wear.

The present invention relates to high speed valves.

There are currently a number of high speed valves available on the market. The switching speed of these valves is typically in the region of 2 to 8 milliseconds. A number of applications, particularly in the process industry, need valves which work substantially faster than this and, in addition, many applications also need valves which can operate at a high frequency. The design of a high frequency, high speed valve has the problem of wear and fatigue to contend with and this is generally the limiting factor in the life of such valves. Often these valves, due to their higher operating frequencies, are required to operate for tens of millions of cycles which is problematic with known designs.

The main point of wear at which many valves fail is the mating of a valve seal, often a rubber pad, with a raised lip surrounding the orifice through which the fluid flows. As valves typically drive the valve seal into the raised lip at a maximum force, wear is progressive and tends to accelerate through out the valve's life.

A high speed of valve operation is effected in PCT application WO02/04851, U.S. Pat. No. 2,036,277 and French patent 697,174. However all these follow traditional valve design in that the armature accelerates until it contacts the valve seal at maximum velocity. WO02/04851 attempts to remedy this by provision of a spring but the spring force required to provide any effective relief severely reduces the holding force of the valve and reduces its performance. This reduction in performance can be overcome by increasing the size of the valve, however this results in a larger valve which takes more energy to power it.

It is the object of the present invention to provide a high speed fluid flow control valve with an improved life which is capable of switching, at a high frequency, relatively high fluid flow rates while only requiring a relatively small amount of power to operate it.

According to the present invention there is provided a valve comprising:
a) a first fluid flow port provided in a first member,
b) a second fluid flow port,
c)a passageway interconnecting the first and second ports,
d) an armature extending into the passageway and comprising a valve closure located in the passageway, the armature being movable between a first position in which the valve closure is spaced from the first fluid flow port thereby permitting flow of fluid through the first port, and a second position in which the armature contacts the first member, the valve closure sealingly closing the first port;
e) an electromagnetic coil operable to cause the armature to assume and/or maintain a selected one of said first and second positions; and dampening means, the dampening means being elastically deformable to absorb energy from the armature as it contacts the first member and to substantially regain its original dimensions once the deforming force has been removed.

The dampening means preferably comprises a layer of viscoelastic material. As the contact faces of the armature and the first member wear due to repeated impact, the dampening means will be deformed by an ever increasing amount providing greater dampening, thus as the valve wears the dampening force imparted on the armature by the dampening means increases thereby reducing the impact force of armature and the first member, thus increasing protection against further wear.

Preferably the valve closure comprises a valve seal provided on the armature. The valve seal preferably engages a valve seat provided surrounding the first fluid flow port. Preferably, during the first actuations of the valve, the valve seal assumes a permanent deformation or set, and, as the valve seal assumes this set, the dampening means is progressively deformed. Preferably the dampening means is dimensioned such that it does not deform until the valve seal has assumed this set.

The armature is preferably pivotably mounted at one end such the pivoted end is substantially in contact with the first member and the valve closure end can move between the first position and the second position.

Preferably the armature is pivoted and moves in an arcuate path such that the impact between the armature and the first member progresses along an angle creating both normal and shear stresses in the dampening means.

In an alternative arrangement the pivot mount is an integral part of the first member.

Preferably the dampening means is attached to, and moves with, the armature and impacts the first member before the armature reaches the end of its stroke. Alternatively the dampening means is attached to the first member of the valve and is deformed by the armature as it approaches the end of its stroke.

Preferably the viscoelastic material is protected from damage due to repeated impact by a layer of a harder plastic with which it is overlaid, preferably the harder plastic is a polyetheretherketone (PEEK)

In a first preferred arrangement the valve is mono-stable and the supply of a pulse of electric current to the coil to energise it will temporarily move the armature to its first position thereby opening the first fluid flow port to allow fluid to flow therethrough, and in the absence of said electric current the fluid pressure within the valve moves the armature into, and holds the armature in, its second position in which it covers the first fluid flow port thereby blocking fluid flow therethrough.

In a second preferred embodiment the valve is mono-stable and the supply of a pulse of electric current to the coil to energise it will temporarily move the armature to its second position in which it covers the first fluid flow port thereby blocking fluid flow therethrough, and in the absence of said electric current the fluid pressure within the valve moves the armature into, and holds the armature in its first position thereby opening the first fluid flow port to allow fluid to flow therethrough.

The valve preferably further comprises an enclosure containing the armature and in which the second port is located so as to be open in the first and second positions of the armature, wherein: the first member comprises a leg extending laterally from an end piece and ending in a magnetic pole.

The valve may further comprise a second leg extending laterally from the end piece, the second leg being of a non-magnetic material. The second leg is preferably of a corresponding shape to the leg of the first member, and has a pole-shaped end.

The first fluid flow port is preferably located in the magnetic pole; the armature and first member forming a magnetic circuit and the coil surrounding a part of the magnetic circuit; the arrangement being such that when a higher fluid pressure prevails at the first port than at the second port, the fluid flow maintains the armature in its first position with the valve closure separated from the first port such that the fluid may flow from the first port to the second port via the enclosure, and when a higher fluid pressure is applied to the second port than the first port the armature will be caused by the fluid to assume its second position with the valve closure closing the second port and checking the fluid flow through the enclosure and when the armature is in its second position and a current is applied to the coil the armature will move from its second position to its first position, thereby overriding the closed position of the valve.

Preferably a non magnetic-surface is provided at the end of the second leg, opposite the magnetic pole, forming a stop which restricts the motion of the armature in the direction away from the magnetic pole.

The first fluid flow port may alternatively be provided within pole shaped end of the second leg.

Preferably the enclosure containing the armature is in part defined by an end piece.

In a preferred arrangement the end-piece is made up of a number of components, one of which forms part of the enclosure. Preferably the end piece is made up of at least two pieces, namely, a central piece forming part of the enclosure and a spacer placed between the central piece and the leg of the first member. Preferably, the central piece and the spacer are made of a magnetic material.

Preferably the enclosure containing the armature is made of the end piece which is constructed of a magnetic material and a second piece made of a non-magnetic material.

Preferably a sealing means, for example an o-ring or similar, is placed between the end piece and the second piece of the enclosure.

Preferably a hole is provided in the second piece of the enclosure through which the pole piece of the magnetic leg protrudes enabling the co-operation of the armature with the pole piece.

In one preferred arrangement the second piece of the enclosure has a face symmetrically opposing the pole piece which acts as an end stop for the armature. In an alternative preferred arrangement the second, non-magnetic leg protrudes through a hole in the second piece of the enclosure enabling a symmetric construction and so facilitating its manufacture. Where there is a second non-magnetic leg, the end piece optionally comprises a three pieces, a central piece forming part of the enclosure, a first spacer placed between the central piece and the magnetic leg protruding from the end piece, and a second spacer placed between the central piece and the second non magnetic leg. At least the central piece and the first spacer are made of a magnetic material.

In one preferred arrangement the second piece of the enclosure forms a bobbin on which the coil is wound and the armature passes longitudinally through the coil, separated therefrom by the bobbin.

In an alternative arrangement the coil surrounds a portion of the magnetic leg.

In one preferred arrangement, giving a first mode of operation, the first fluid port is provided in the magnetic pole and the second fluid port is provided in the enclosure. In this arrangement the first fluid flow port is the inlet and normally fluid flows into that port and out of the second fluid flow port in the enclosure, which acts as the outlet. In this mode the fluid pressure differential normally maintains the armature in its open position thereby enabling flow through the valve. If the flow is reversed, as the flow starts to reverse, overpressure on the armature and Bernoulli forces will draw the armature towards its closed position, a pressure differential to be established across the armature which fully closes the valve thereby checking backflow. When the armature is in its position where it is separated from the magnetic pole, i.e. the valve is in its open position and fluid is passing from the inlet to the outlet, and power is supplied to the coil, the position of the valve armature due to normal operation will be temporarily over-ridden and the armature will move towards the magnetic pole, closing the first fluid flow port therein. Removal of power to the coil will enable the valve to resume its normal position.

In an alternative arrangement, giving a second mode of operation, the first fluid port is provided in the enclosure or the second, non magnetic leg opposite the magnetic pole and the second fluid flow port is provided in the enclosure, most preferably generally at an angle to the first fluid flow port. In this arrangement the first fluid flow port is the inlet and the second fluid flow port is the outlet. In normal operation flow flows in the inlet and out of the outlet and the fluid flow holds the port in its open position. When flow is reversed, overpressure on the armature and a Bernoulli force will draw the armature towards the inlet thereby closing the inlet and checking flow in that direction. Providing there is a higher pressure on the outlet than on the inlet, i.e. flow is still trying to flow in the reverse direction, the pressure differential across the armature will maintain the valve closed and prevent flow in that direction. When the armature is in a position spaced from the magnetic pole and power is applied to the coil, magnetic forces will cause the armature to move away from the inlet port towards the magnetic pole thereby opening a flowpath through the valve permitting reverse flow.

In another alternative arrangement, giving a third mode of operation, the first fluid flow port is the outlet and the second fluid flow port is the inlet. In this arrangement, in normal operation the armature is in its position spaced from the magnetic pole and closing the outlet port and is held in this closed position by pressure differential across the armature (i.e. between the enclosure and the outlet) effecting a valve which normally checks the flow. When the armature is in this position spaced from the magnetic pole closing the outlet and power is applied to the coil, magnetic forces will cause the armature to move away from the outlet port towards the magnetic pole thereby opening a flowpath through the valve permitting flow in the direction in which it is normally checked. When the power is removed from the coil flow will start to reverse overpressure on the armature and Bernoulli's force will draw the armature towards the outlet thereby closing the outlet and checking flow again. If there is a greater fluid pressure at the outlet than the inlet then the flow will move the armature and allow flow from the outlet to the inlet.

A recess or cavity may be provided in the magnetic pole or in the second non magnetic leg, whichever does not have a fluid flow port formed therein, and a flow path is provided between the enclosure and the recess or cavity, such that when the armature is located against said magnetic pole or second non magnetic leg it at least partially covers the cavity or recess and, when closing due to attempted fluid flow in its checked direction, fluid pressure on the side of the armature opposite the fluid flow port towards which it is closing (overpressure on the armature) is increased at the start of the movement of the armature complementing the Bernoulli forces closing the armature and decreasing the time which it takes for the valve to close, therefore providing an improved check function.

Alternatively, the second leg is made of a magnetic material and the valve comprises permanent magnetic means to provide a north and a south permanent magnetic pole at the ends of each of the first and second magnetic legs, the first fluid flow port being provided in the first magnetic leg, and the armature being movable between a first stable position adjacent the magnetic pole of the first magnetic leg thereby blocking the first fluid flow port therein and a second stable position adjacent to the magnetic pole of the second magnetic leg whereby the first fluid flow port is unblocked, the other end of the armature being substantially adjacent a midpoint of the magnetic means, thus providing a circuit between the armature, the magnetic pole which it is adjacent and the part of the magnetic means between the magnetic pole and the other end of the armature; and the coil surrounding said armature such that when energised with a pulse of electricity the armature is caused to move from one stable position to its other stable position.

Preferably the enclosure containing the armature is in part defined by an end piece and wherein a sealing means is placed between the end piece and the main section of the enclosure.

Preferably the end piece is a permanent magnet and forms the permanent magnetic means.

Preferably the end piece comprises three pieces, one central piece forming part of the enclosure and being made of a soft magnetic material and two spacers comprising permanent magnets either side of the central piece, between the central piece and the magnetic legs.

One or both spacers are preferably wedge shaped whereby a spacer may be inserted between the central piece and the first or second leg to the required degree to substantially fill the gap therebetween.

Preferably a wedge shaped spacer is inserted between the central piece and the first or second leg to a varying degree so as to effect the desired spacing therebetween, preferably so as to be able to accommodate tolerances in the spacing between the said leg and the central piece.

Preferably two holes are provided in the enclosure opposite one another through which the poles of the first and second magnetic legs protrude thereby enabling the co-operation of the armature with the poles.

Preferably the enclosure forms a bobbin on which the coil is wound and the armature passes longitudinally through the coil, separated therefrom by the bobbin, the dampening material preferably being deformed between the armature and the bobbin.

Preferably the valve further comprises a secondary dampening means to further reduce the force with which the armature impacts the pole of a leg comprising at least one ring of a non-magnetic, electrically conducting material surrounding at least a part of at least one of the poles such that as the armature switches from one position to the other there is a sharp increase in the magnetic flux through the pole which the armature is approaching, the flux increase setting up a current within the dampening ring creating a back electromotive force (EMF) which opposes the movement of the armature towards the pole thus providing a dampening force on the armature to reduce the force with which the armature impacts the pole.

Preferably the ring of material is circular and preferably comprises copper or silver, more preferably the dampening ring comprises a continuous coil of a number of turns of wire. Preferably one of said ring is provided on the pole of each leg.

In an alternative preferred arrangement the valve has three ports, one in each of the said surfaces and the third in a neutral area and being permanently open.

The permanent magnets are preferably rare earth magnets, more preferably Neodymium Iron Boron (NdFeB) magnets. Preferably, during assembly the spacers are not magnetised, and once the valve is assembled the spacers are magnetised to form the two permanent magnets. This greatly facilitates the handling of the spacers and enables them to be easily inserted to the requisite depth to accommodate the variation in manufacturing tolerances. It additionally eliminates any assembly errors wherein, if pre-magnetised, the magnets could be placed in the wrong polar orientation.

Preferably, the valve seal comprises resilient sealing means and protrudes from the armature. Abutment means are preferably provided to limit movement of the armature as it moves towards the valve seat, thereby limiting the degree of compression of the resilient sealing means when engaged with the valve seat.

Preferably the abutment means comprises a first surface located adjacent to the valve seat and adapted to be engaged by the armature in its second position, the valve seat being on a second surface recessed relative to said first surface.

Preferably said first surface is an annular surface surrounding the valve seat and adapted to be engaged by a surface of the armature surrounding the valve seal.

Preferably the valve seat comprises a raised lip extending from the second surface, more preferably the sealing edge of the raised lip is recessed from the first surface.

Preferably the first surface surrounding the recessed second surface is chamfered, crowned or radiused.

Thus, as the valve wears the chamfer or recess is able to accommodate any “roll over”, that is any material from the first surface which is displaced by wear in the direction of the recess but which is still attached to said first surface.

Preferably the surface of the armature surrounding the valve seal completely overlaps the edges of the abutment means with which it comes into contact. Preferably the armature is made of a harder material than the abutment means, whereby any wear that does occur tends to be limited to wear of the abutment means with no or minimal wear to the armature.

The first member may alternatively be substantially U shaped and the armature is positioned such that it can assume one of two positions where it either bridges the space between the two ends of the first member such that both ends of the armature are substantially in contact with the first member, or in which both ends of the armature are apart from the first member.

Specific embodiments of the invention will now be described, by way of example only, with reference to the drawings in which:

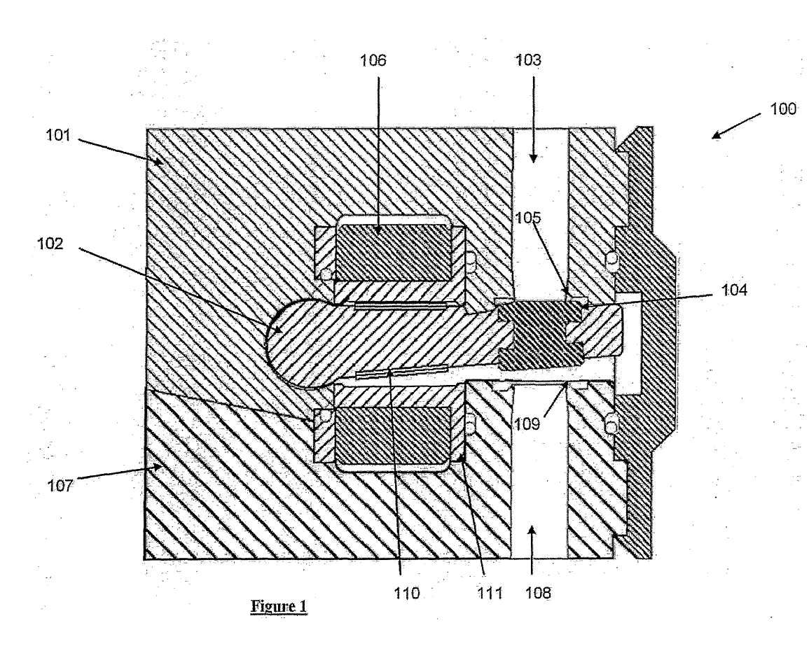

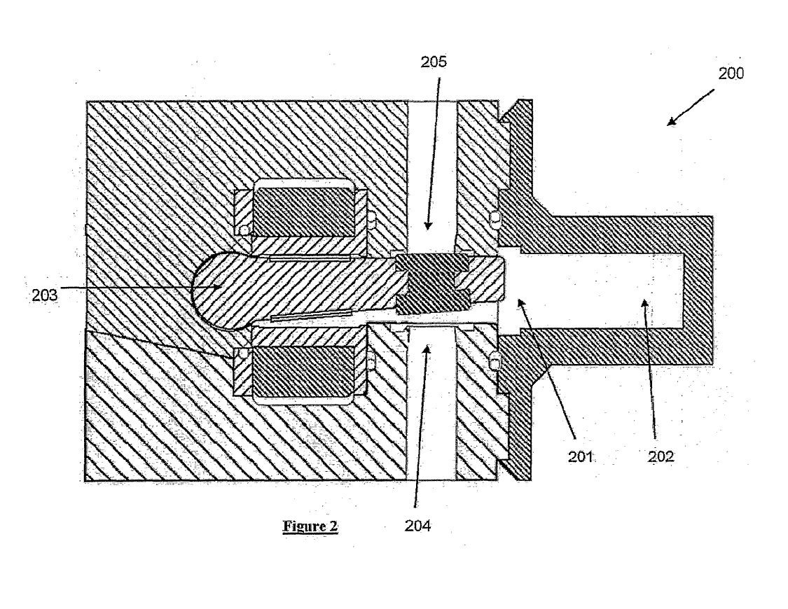

FIG. 1 is a cross sectional view of a valve according to a first embodiment of the invention;

FIG. 2 is a cross sectional view of a valve according to a second embodiment of the invention;

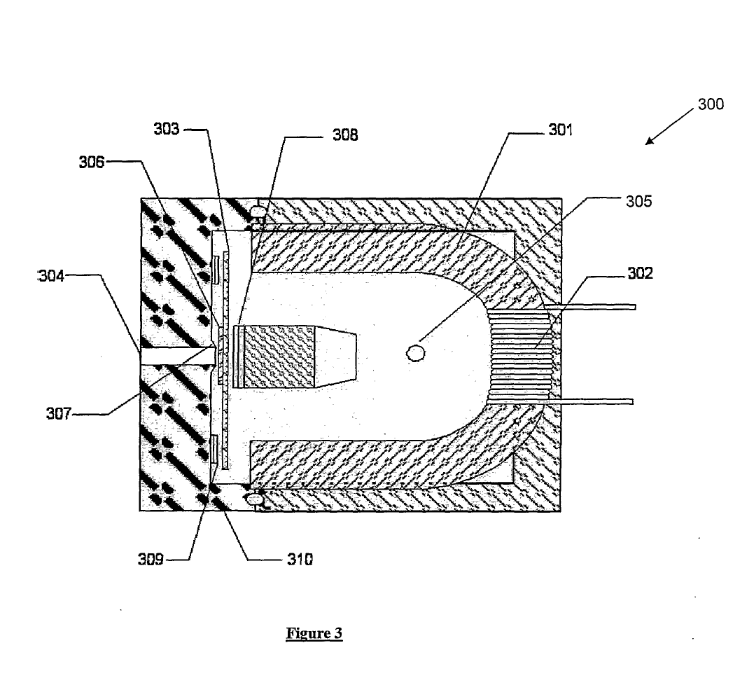

FIG. 3 is a cross sectional view of a valve according to a third embodiment in accordance with the invention;

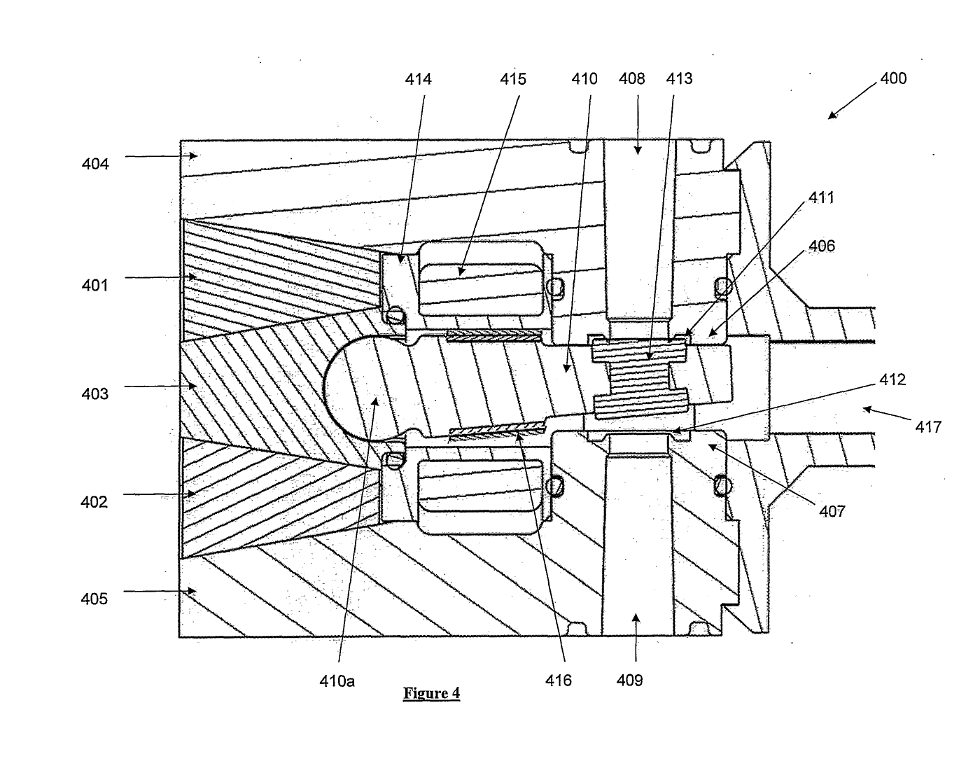

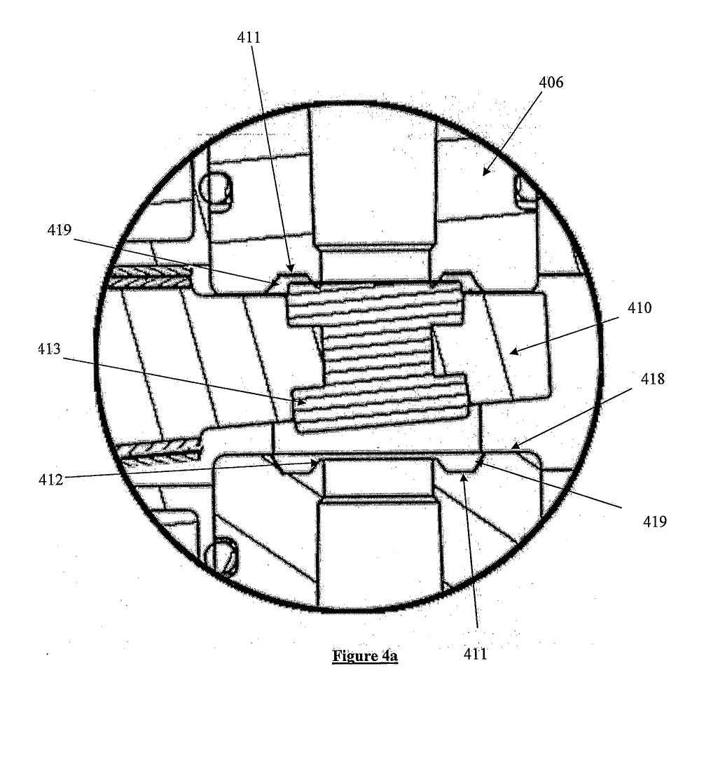

FIG. 4 is a cross-sectional view of a bi-stable valve according to a fourth embodiment of the invention;

FIG. 4a is a detail view of the valve seat arrangement of FIG. 4;

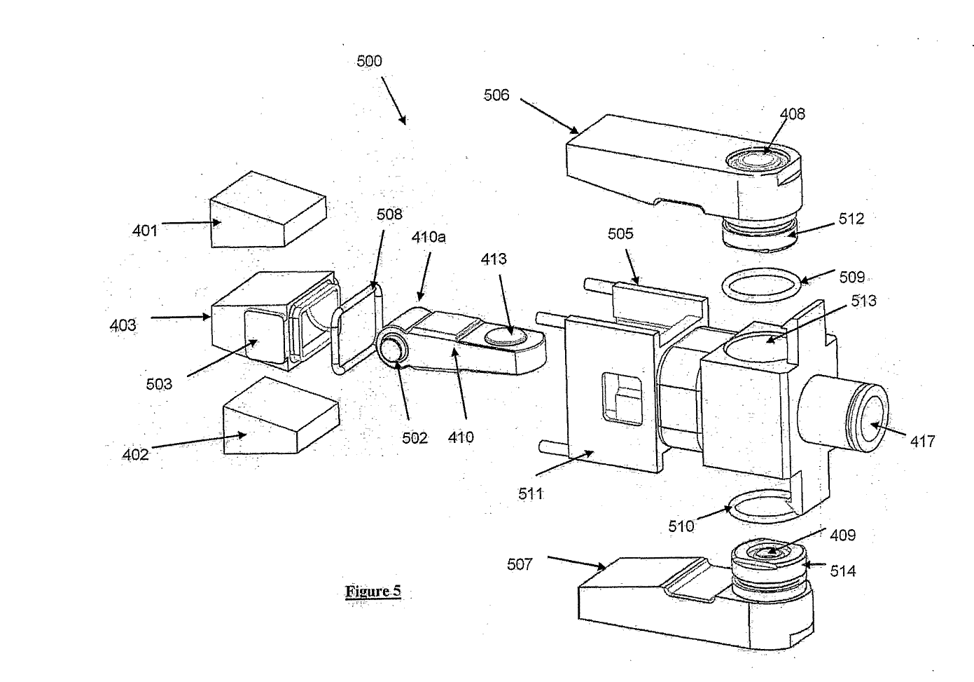

FIG. 5 is an exploded perspective view of a bi-stable valve according to a fifth embodiment of the invention;

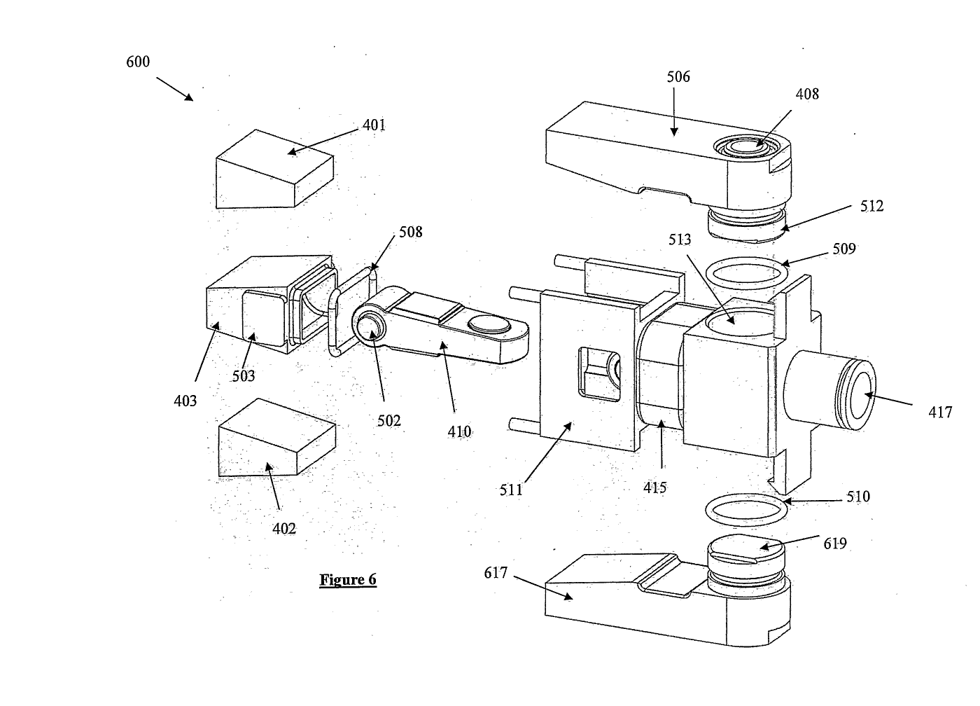

FIG. 6 is an exploded view of a check valve in accordance with a sixth embodiment of the invention;

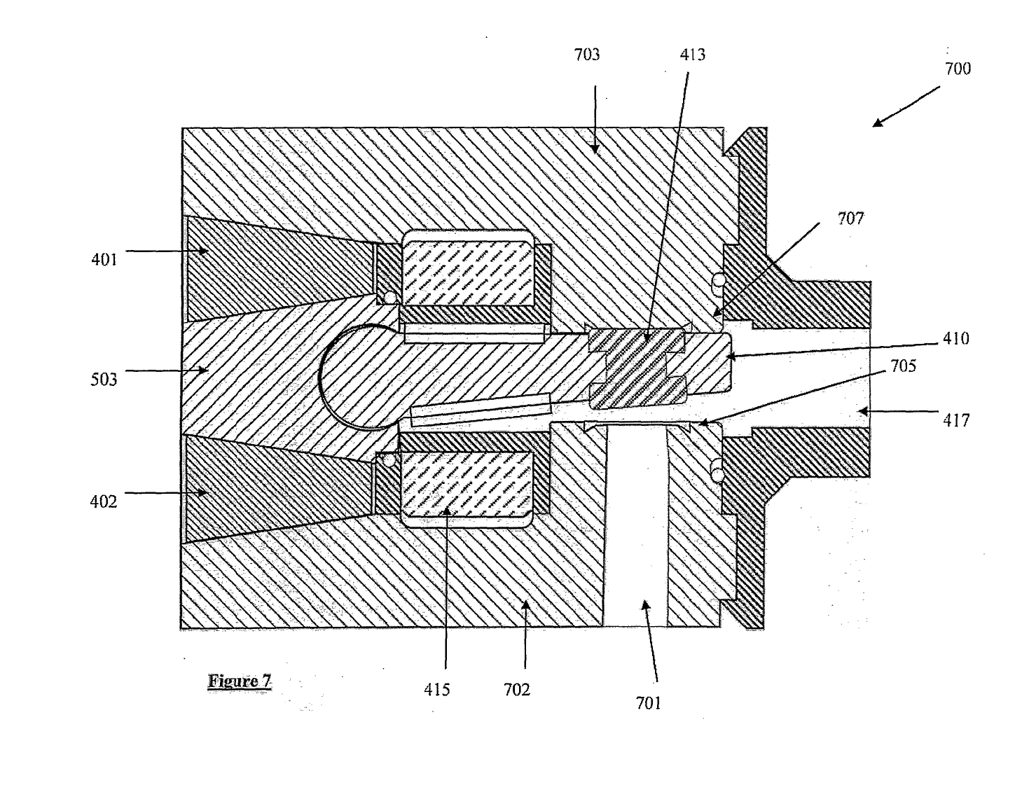

FIG. 7 is a section view of a check valve according to a seventh embodiment of the invention;

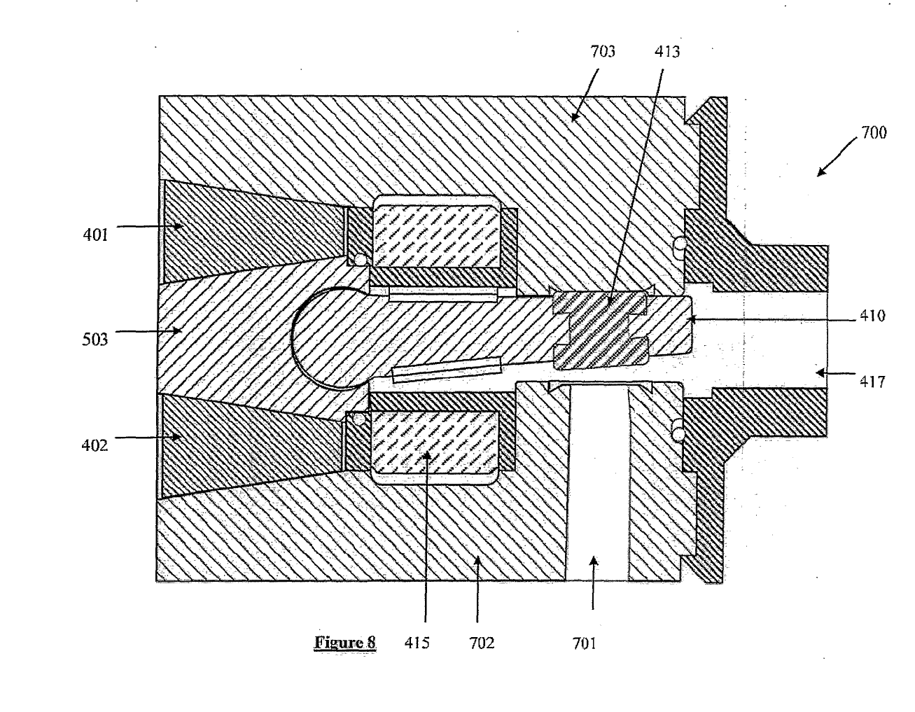

FIG. 8 illustrates the check valve of FIG. 7 in an alternative mode of operation;

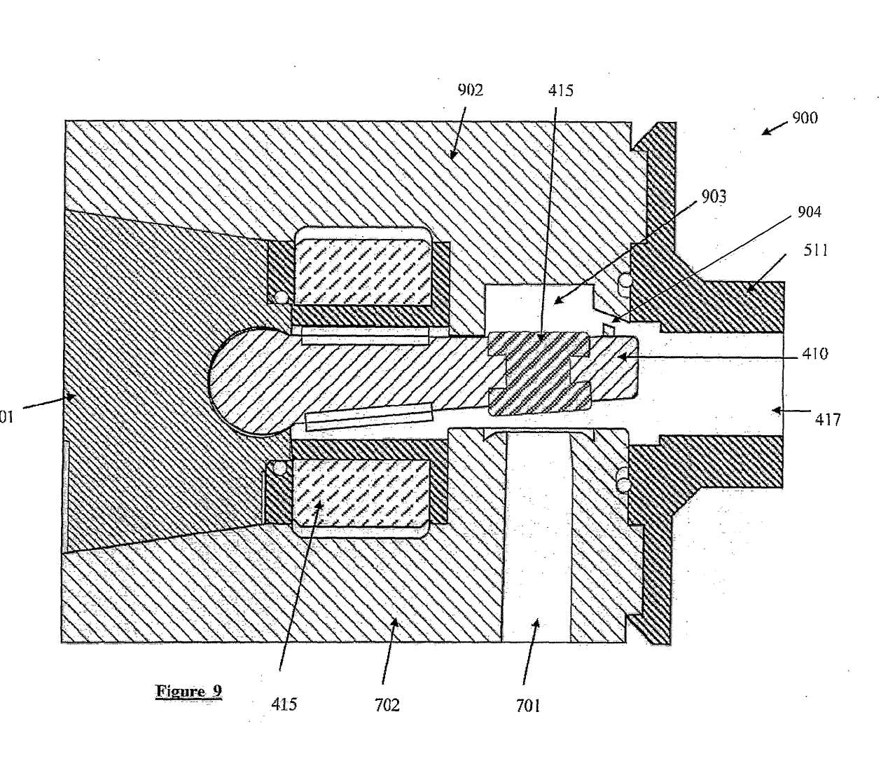

FIG. 9 is a sectional view of a check valve according to an eighth embodiment of the invention; and

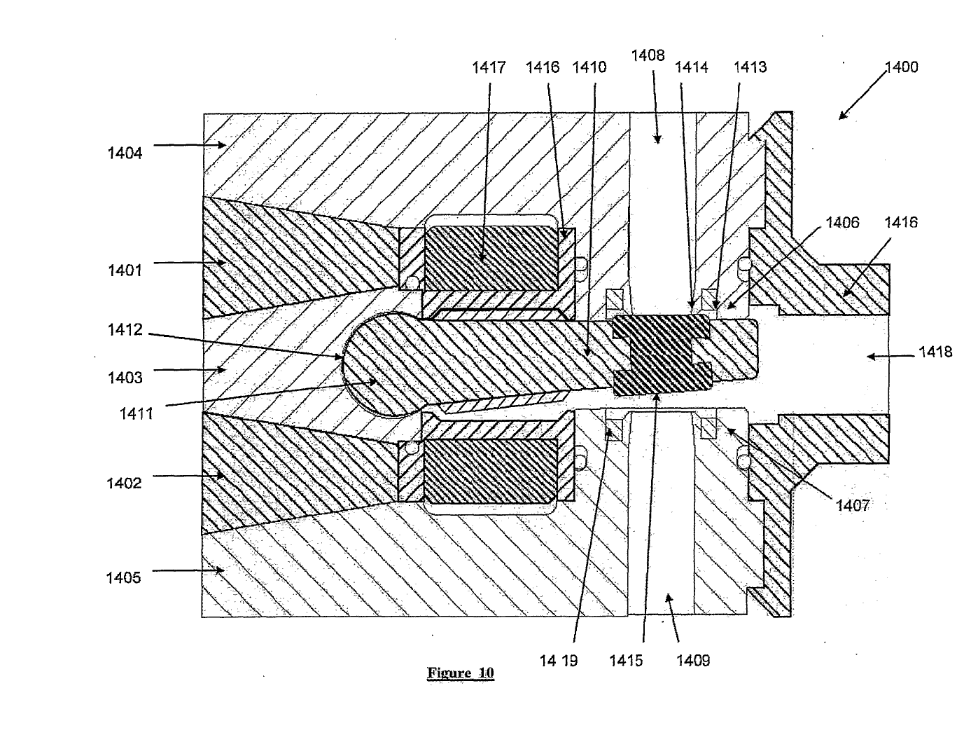

FIG. 10 is a section view of a valve according to a ninth embodiment of the invention.

Referring to FIG. 1 a valve 100 is shown comprising a magnetic circuit comprising a first member 101 and an armature 102 pivotally engaged with the first member such that the free end may assume a position in contact with the first member or may assume an alternate position away from the first member 101. When the armature 102 is in contact with the first member it blocks a valve port 103 there through in a sealing manner by means of engagement of a valve seal 104 with a valve seat 105.

The valve port 103 is supplied with a pressurised source of fluid, for example air. A coil 106 surrounds the armature 102 which, when supplied with an electric current, creates a magnetic field in the armature 102 attracting it to pivot such that the free end moves into contact with the first member 101. When the electric current is removed the air pressure in valve port 103 moves the armature 102 away from the valve port 103 and towards non magnetic section 107 containing an outlet valve port 108 of the valve. The valve seal 104 seals against a valve seat 109 in the non-magnetic section 107 of the valve manufactured of PEEK.

The valve seal 104 is made of a resilient material and may be any of a number of materials commonly used in valve seals, for example Styrene Butadiene rubber (SBR) or a modified SBR, and is carried by the armature 102. The valve seal 104 must seal against valve seat 109 or valve seat 105. The metal of the armature 102, when at the limits of its travel, contacts the metal of the first member 101 or the non magnetic section 107. It is important to maintain metal to metal contact of the armature 102 against the first member 101 or the non magnetic section 107 so as to provide the requisite sealing force.

The provision of a short pulse of electricity to the coil 106 will activate the valve quickly to result in a short puff of air being emitted. The valve is provided with dampening pads 110 on the armature 102. Each dampener pad 110 comprises two thin layers, the first of which is adjacent the armature 102 and is a viscoelastic material, for example Polymer 11P05 manufactured by 3M™. The second layer, which contacts the valve core 111 when the armature 102 moves, is a polymer with good wear properties, for example a polyetheretherketone (PEEK). The PEEK layer protects the viscoelastic material from the wear which would otherwise result from repetitive impact as the valve switches. As the armature 102 pivots through an arc the dampener pad 110 will experience both shear and normal components to the force upon it at impact. After the armature 102 moves away from one of its positions adjacent to a valve port, the viscoelastic material will regain its original dimensions ready for the next impact.

The dampener pads 110, valve seal 104, and valve seats 105, 109 are dimensioned such that as the armature 102 moves from one stable position to the other the first contact is between the dampener pad 110 and the valve core 111, on which the coil is wound, the second contact is between the valve seal 104 and the valve seat 105, 109, and the final contact is with the metal of the armature 102 in contact with either the first member 101 or the non magnetic section 107 depending on the position of the armature. When initially manufactured the dampener pad 110 may not engage with the valve core 111 until such time as the valve seal 104 has taken on some permanent deformation. During use, as there is wear between the armature 102 and the first member 101, and/or the non magnetic section 107, the dampening pad 110 is compressed on impact by an increasing degree, thus the more worn the valve becomes, the more the dampening and thus the greater the protection against further wear.

Referring to FIG. 2, a valve 200 is shown which is substantially the same as the valve 100 of FIG. 1, but which is for use with compressible fluids, for example gasses, in which an additional valve port 201 is provided connected to a small reservoir area 202. When the valve is in its shut position, i.e. the armature 203 is closing against the outlet valve port 204 the reservoir is charged with compressed fluid, e.g. air. When the valve is actuated to move the armature 203 to its position closing against the inlet valve port 205 the reservoir discharges into the valve via valve port 201 and then out of the valve via outlet valve port 204, thereby giving a defined and repeatable pulse of air out of the valve on each actuation.

Referring to FIG. 3 a valve 300 is shown in which a magnetic core 301 is surrounded by a coil 302, to which the provision of an electric current causes magnetic poles to be set up at either end thereof. The induced magnetic field attracts the armature 303 towards the magnetic core, thereby opening outlet valve port 304. When the current is removed, internal air pressure within the valve from the inlet valve port 305 closes the armature 303 back onto the valve port 304 and seals by means of a valve seal 306 closing on a raised valve seat 307. A dampening pad 308 of similar construction to that described in relation to FIG. 1 is positioned such that when the armature 303 is attracted towards the magnetic core 301 it deforms the dampening pad 308 before contact between the armature 303 and magnetic core thus reducing the wear. A second dampening pad 309 is provided on the valve body 310 such that some of the impact between armature 303 and raised valve seat 307 is absorbed by the deformation of the dampening pad 309.

Referring to FIG. 4 a valve 400 is shown comprising two spacers in the form of permanent magnets 401, 402, preferably NdFeB rare earth magnets, separated by a central piece 403 made of a magnetic material. The spacer magnets 401, 402 are orientated such that one has a north pole facing the central piece 403 and the other has a south pole facing the central piece 430 such that effectively the two magnets 401, 402 and the central piece 403 together form a longer magnet. Extending from the outer faces of the magnets 401, 402 and at substantially at 90 degrees to the north south axis thereof there are two magnetic circuit legs 404, 405, each of which terminate in a pole piece 406, 407 through which valve ports 408, 409 are provided. The pole pieces 406, 407 define an air gap in which one end of an elongate armature 410 is located.

The magnets 401, 402 are wedge shaped and as such can be inserted between the central piece 403 and the magnetic circuit legs 404, 405 to a varying degree and can therefore accommodate any difference in separation of the two surfaces they are placed between which may occur as a result of size differences due to manufacturing tolerances. This enables the circuit legs 404, 405, the pole pieces 406, 407, the armature 410 and the valve seal 413 to be angularly aligned and then the magnets 401, 402 can be inserted to the necessary degree to fit in the gap between the central piece 403 and the magnetic circuit legs 404, 405 respectively.

The central piece 403 defines a pivot socket 403a. The other end 410a of the armature 410 is received within the pivot socket 403a. The said other end 410a of the armature 410 is of a rounded, complementary shape to the pivot socket 403a, such that only a minimum air gap exists between the end 410a of the armature 410 and the internal surface of the central piece 403, to thereby ensure that as the armature 410 pivots, there is a constant area of magnetic connection between armature 410 and central piece 403.

The end of the armature 410 in the air gap between the two pole pieces 406, 407 assumes a stable position adjacent and in contact with either magnetic pole piece 406 or pole piece 407 thereby blocking the valve port 408 or valve port 409, respectively. On each pole piece surrounding the mouth of the valve port is a recessed area 411 from which extends a valve seat in the form of a raised lip 412. The raised lip 412 engages with a valve seal 413 on the end of the armature 410. The valve seal 413 shown is constructed as one piece and passes through the armature 410, but could equally be made of two individual seals adhered to either side of the armature. The diameter of the recess 411 is larger than the diameter of the valve seal 413 such that when the armature 410 is against a pole piece 406, 407 the valve seal 413 engages with the raised lip 412 without preventing direct contact between the adjacent faces of the armature 410 and the pole piece 406, 407. The valve seal material deforms on impact and after a number of cycles will develop a slight permanent deformation at the line of contact with the raised lip 412. A valve core 414 acts as both a support for the valve structure and as a bobbin on which is wound a coil 415. The coil 415 has a number of electric connectors (not shown) and by providing a short pulse of current between selected pins the magnetic circuit can be de-stabilised causing the armature 410 to pivot and move from one stable position adjacent to one pole 406 to its alternative stable position adjacent the other pole 407.

Situated on either side of the armature 410 in the region surrounded by the coil is a dampener pad 416. Each dampener pad 416 comprises two thin layers, the first of which is adjacent the armature 410 and is a viscoelastic material, for example Polymer 11P05 manufactured by 3M™. The second layer, which contacts the valve core 414 when the armature moves, is a polymer with good wear properties, for example a polyetheretherketone (PEEK). The PEEK layer protects the viscoelastic material from the wear which would otherwise result from repetitive impact as the valve switches. As the armature 410 is moving through an arc the dampener pad 416 will experience both shear and normal components to the force upon it at impact. After the armature 410 moves away from one of its stable positions, the viscoelastic material will regain its original dimensions ready for the next impact.

The dampener pads 416 and armature 410, valve seals 413, raised lips 412 and pole pieces 406, 407 are dimensioned such that as the armature 410 moves from one stable position to the other the first contact is between the dampener pad 416 and the valve core 414, the second contact is between the valve seal 413 and the raised lip 412, and the final contact and stable position of the valve is with the metal of the armature 410 in contact with one of the pole pieces 406, 407. When initially manufactured the dampener pad 416 may not engage with the valve core 416 until such time as the valve seal 413 has taken on some permanent deformation. During use, as there is wear between the armature 410 and the pole piece 406, 407, the dampening pad 416 is compressed on impact by an increasing degree, thus the more worn the valve becomes, the more the dampening and thus the greater the protection against farther wear.

In a first mode of operation, functioning as a 3/2 valve, the valve ports 408, 409 in each of the pole pieces provide the inlet and the exhaust ports respectively and the valve port 417 in the valve core provides the outlet, the armature 410 being switchable between its two stable positions to connect the flow from inlet 408 to outlet 417 or from outlet 417 to exhaust 409. In a second mode of operation, functioning as a diverter valve, the valve port 417 in the valve core provides the inlet port and the valve port 408, 409 in each of the pole pieces provides the two alternative outlet ports, the armature 410 being swichable to select one or other of the outlets. In a third mode of operation, functioning as an on/off valve, one of the valve ports (for example 408) in the pole pieces is permanently plugged (or alternatively omitted) and the armature 410 is switchable to allow or block flow between the valve port 409 in the other pole piece and the valve port 417 in the valve core.

Referring to FIG. 4a the sealing arrangement of FIG. 4 is shown in detail. As the armature 410 comes into contact at high speed with the surface 418, the valve seal 413 contacts the raised lip 412 provided within the recess 411. The seal 413 protrudes from the armature 410 such that as it contacts with the raised lip 412 the material can expand radially close to the surface of the valve seal 413 and absorb the shock of impact. The seal 413 overlaps the edges of the raised lip 412 such that it can accommodate any miss-alignment as the two parts come together. The edges of surface 418 surrounding the recess have a chamfer 419 and the recess 411 is sized such that such that when the armature 410 contacts the surface 418 it overlaps the edges of the recess for improved wear characteristics. The chamfer 419 serves the purpose of removing the sharp edge of surface 418 which in not conducive to low wear. The chamfer 419 is shown for example only and may easily be replaced with another means for removing the sharp edge, e.g. a radius or crown.

The armature 410 is manufactured of a harder material than the pole pieces 406, 407 with which the armature 410 contacts so that any wear occurs to the surface 418, rather than to the armature 410. The chamfer 419 gives some room to accommodate “roll over” of the lip which can occur at the edge of a surface as a result of wear. Provision of this area to accommodate “roll over” ensures that any roll over which occurs does not encroach on the edges of the seal 413 when the valve is sealed, which would accelerate its wear. When the armature 410 and surface 418 are in contact the protruding part of the seal 413 fits totally within the recess 411 and has sufficient clearance therein that when the raised lip 412 compresses the seal 413 causing it to expand radially in its protruded section there is no interference between the seal 413 and the sides of the recess 411.

FIG. 5 shows a valve 500 which is substantially the same as the valve of FIG. 4, with the following modifications. The same reference numbers are retained for corresponding features.

In this valve 500, the armature 410 has integral pivot pins 502 provided at its other end 410a. The pivot pins 502 sit within recesses 503 formed within the central piece 403, such that the armature 410 can pivot about the pivot pins 502.

An enclosure 511 surrounds the armature 410, said enclosure 511 being made of a non magnetic material, for example a rigid plastic material such as a polyetheretherketone (PEEK). The enclosure 511 seals against the spacer 403 and two circuit legs 506, 507 by means of o-rings 508, 509, 510.

Adjacent the central piece 403 on one side is a first spacer magnet 401 and adjacent the magnet 401 is a first leg 506 extending therefrom. Adjacent the central piece 403 on its other side is a second spacer magnet 402 and adjacent the second magnet 402 is a second leg 507 extending therefrom. The central piece 403, legs 506, 507 and armature 410 are made of a magnetic material with good mechanical and anti-corrosive properties (e.g. Chrome Core™ 12 from Carpenter Technology Corporation). The legs 506, 507 each end in a magnetic pole 512, 514 which respectively have valve ports 408, 409 provided therethrough.

A hole 513 is provided through the enclosure 511 which, when the valve 500 is assembled, receives the poles 512, 514 which sealingly engaged therein by means of o-rings 509, 510.

FIG. 6 shows an exploded view of a check valve 600, which is substantially the same as the valve 500 of FIG. 5, with the following modifications. The same reference numbers are retained for corresponding features.

In this valve 600, the second leg 617 is made of a non-magnetic material and is of the same size and shape as the leg 507 of FIG. 5, and includes an element 619 of the same size and shape as the pole 514 on leg 507 of FIG. 5. The second spacer magnet 402 may also be replaced by a non-magnetic spacer of the same size and shape. The non-magnetic leg 617 and the second magnet 402 are assembled in the same manner as their corresponding elements in FIG. 5, such that the pole-shaped end 619 of the leg 617 passes through a hole (not shown) in the enclosure 511 and is sealingly engaged therein by an o-ring 510. The provision of the second magnet 402 (or a non-magnetic replacement spacer) and the non-magnetic leg 617 enables symmetry in the manufacture of the valve 600.

In this valve 600 valve port 408 forms the inlet port and valve port 417 forms the outlet valve port such that when no current is applied to the coil 415 fluid pressure applied to the inlet valve port 408 freely flows through the enclosure and out of the outlet valve port 417, the pressure of the fluid maintaining the armature 410 pivoted into a position where it does not obstruct the fluid flow. When the flow is reversed, i.e. fluid pressure is applied at the outlet valve port 417 and attempts to flow through the enclosure and out of the inlet valve port 408 Bernoulli forces on the armature 410 draw it closed and overpressure on the armature 410 holds it closed such that flow in the reverse direction is prevented.

When the armature 410 is in its position away from the pole 512, i.e. in this case when the flow is flowing in the inlet valve port 408 and out of the outlet valve port 417, and a current is applied to the coil 415 the armature 410 becomes magnetised and moves to its position adjacent the pole 512 closing the magnetic circuit and blocking inlet valve port 408 thereby over riding the previous position of the valve and closing it to flow in both directions.

The face of the pole-shaped element 619 at the end of the leg 617 functions as a stop for the armature 410 to limit its travel in the direction away from the magnetic pole 512. This maintains a maximum separation of armature 410 and pole 512 ensuring that when a current is provided the air gap is not too great promoting a fast movement of the armature from one position to the other. This separation is also important to ensure that the air flow in the reverse direction induces the required Bernoulli force required to close the valve. In one embodiment a separation of approximately ⅓ the valve port diameter is used but this may vary depending on the geometry of the valve.

Referring to FIG. 7 a check valve 700 of similar construction to the valve 600 described in reference to FIG. 6 is shown. The valves differ in respect to the position of the inlet valve port, where as in FIG. 6 the inlet valve port 408 is shown in the magnetic pole 512, in the valve 700 of FIG. 7 the inlet valve port 701 is placed in the non magnetic leg 702 and the magnetic leg 703 has no valve port therein. In all other respects the construction of the valves is identical.

Operating in its second mode of operation, as shown, fluid pressure applied at the inlet valve port 701 passes through the enclosure 511 and passes out of the outlet valve port 417. When the flow is in this direction the pressure of the fluid moves the armature 410 to the position in which it is shown allowing flow from inlet valve port 701 to outlet valve port 417. If the flow direction is reversed, Bernoulli forces cause the armature 410 to pivot and move to a position in which the armature 410 is adjacent the face 705 of the non magnetic leg 702 thereby closing the inlet valve port 701, checking flow in the reverse direction. When in this position, application of a current to the coil 415 will create a magnetic field in the armature 410 causing it to move toward the magnetic pole 707 thereby temporarily over-riding the current valve position (checked) and temporarily allowing flow in the reverse direction (from outlet 417 to inlet 701). Removal of the current to the coil 415 will allow the armature 410 to resume its position, checking the flow.

Referring to FIG. 8 the check valve 700 of FIG. 7 is shown in an alternative mode of operation. In this mode of operation valve port 417 serves as the inlet port and valve port 701 serves as the outlet port. In this normal mode of operation the flow is normally checked, i.e. when a fluid pressure is applied to the inlet 417 the Bernoulli forces will move the armature 410 to close the outlet valve port 701. Application of a current to the coil 415 will cause the armature 410 to move as described in relation to FIG. 7 temporarily allowing flow through the valve 700. If the pressure at the outlet valve port 701 exceeds that at the inlet valve port 417 then flow will be allowed to pass unchecked through the valve 700 in the reverse direction.

Referring to FIG. 9 a valve 900 is shown which is substantially the same as the valve 700 of FIGS. 7 and 8, with the following modifications. The same reference numbers are retained for corresponding features.

In this valve 900, the central piece 503 and spacer magnets 401, 402 of FIGS. 7 and 8 are replaced with one solid end piece 901 made of a magnetic material. The solid end piece 901 reduces the number of parts and thereby simplifies the manufacture but marginally increases the weight of the valve.

In addition, in this valve 900 the magnetic leg 902 defines a cavity 903 which is in fluid communication with interior of the enclosure 511 via hole 904. When fluid flows through the valve 900 in the direction which is normally checked, pressure in the cavity 903 will generate a force upon the surface of the armature 410 opposite the port towards which it is closing (overpressure on the armature) which will act in addition to the Bernoulli force closing the armature and decrease the time which it takes for the valve to close, therefore providing an improved check function.

It will be appreciated that these features shown may be integrated into any of the above described valves operating in their various modes.

Referring to FIG. 10 a cross sectional view of a valve 1400 is shown, the valve 1400 comprising two permanent spacer magnets 1401, 1402, preferably NdFeB rare earth magnets, separated by a central piece 1403 made of a magnetic material. The magnets are orientated such that one has a north pole facing the spacer and the other has a south pole facing the central piece such that effectively the two magnets 1401, 1402 and the central piece 1403 together form a longer magnet. Extending from the outer faces of the magnets 1401, 1402 and at substantially at 90 degrees to the north south axis thereof there are two magnetic circuit legs 1404, 1405, each of which terminate in a pole piece 1406, 1407 through which valve ports 1408, 4109 pass. The pole pieces 1406, 1407 define an air gap in which is one end of an elongate armature 1410. The armature 1410 has an integral pivot 1411 which sits in a recess 1412 in the central piece 1403. The end of the armature 1410 is rounded and is closely matched to the shape of recess 1412 with a minimum air gap to ensure that as the armature 1410 rotates on its pin 1411 there is a constant area of magnetic connection between armature 1410 and central piece 1403 and the air gap therebetween is a minimum. The end of the armature 1410 in the air gap between the two pole pieces 1406, 1407 assumes a stable position adjacent and in contact with either magnetic pole piece 1406 or pole piece 1407 thereby blocking the valve port 1408 or valve port 1409, respectively. On each pole piece surrounding the mouth of the valve port is a recessed area 1413 from which extends a valve seat in the form of a raised lip 1414. The raised lip 1414 engages with a valve seal 1415 on the end of the armature 410. The valve seal 1415 shown is constructed as one piece and passes through the armature 1410, but could equally be made of two individual seals adhered to either side of the armature. The diameter of the recess 1413 is larger than the diameter of the vale seal 1415 such that when the armature 1410 is against a pole piece 1406, 1407 the valve seal 1415 engages with the raised lip 1414 without preventing direct contact between the adjacent faces of the armature 1410 and the pole piece 1406, 1407. The valve seal material deforms on impact and after a number of cycles will develop a slight permanent deformation at the line of contact with the raised lip 1414. A valve core 1416 acts as both a support for the valve structure and as a bobbin on which is wound a coil 1417. The valve core 1416 is manufactured of an injection moulded plastic and seals against the central piece 1403 and the two circuit legs 1404, 1405 by means of o-rings. The valve core 1416 has a valve port 1418 therein thus giving a three valve port valve. The coil 1417 has a number of electric connections and by providing a short pulse of current between selected connections the magnetic circuit can be de-stabilised causing the armature 1410 to pivot on its pin 1411 and move from one stable position adjacent to one pole to its alternative stable position adjacent the other pole.

Recessed into each pole 1406, 1407 is a continuous coil 1419 of fine copper wire, effectively providing a plurality of rings which, as the flux increases during the movement of the armature 1410 provides a back EMF which dampens the impact with which the armature 1410 impacts the pole 1406, 1407.

The continuous coil 1417 is wound on a central bobbin (not show) for example a thin plastic injection moulded tube, to give it some rigidity for handling during assembly.

In a first mode of operation, functioning as a 3/2 valve, the valve ports 1408, 1409 provide the inlet and the exhaust ports respectively and the valve port 1418 in the valve core provides the outlet, the armature 1410 being switchable between its two stable positions to connect the flow from inlet 1408 to outlet 1418 or from outlet 1418 to exhaust 1409. In a second mode of operation, functioning as a diverter valve, the valve port 1418 in the valve core provides the inlet port and the valve ports 1408, 1409 in each of the pole pieces provide the two alternative outlet ports, the armature 1410 being switchable to select one or other of the outlets 1408, 1409. In a third mode of operation, functioning as an on/off valve, the valve port 1409 is permanently plugged (or alternatively omitted) and the armature 1410 is switchable to allow or block flow between the valve port 1408 in the other pole piece and the valve port 1418 in the valve core.

1-51. (canceled)

52. A valve comprising:
a) a first fluid flow port provided in a first member,
b) a second fluid flow port,
c) a passageway interconnecting the first and second ports,
d) an armature extending into the passageway and comprising a valve closure located in the passageway, the armature being movable between a first position in which the valve closure is spaced from the first fluid flow port thereby permitting flow of fluid through the first port, and a second position in which the armature contacts the first member, the valve closure sealingly closing the first port;
e) an electromagnetic coil operable to cause the armature to assume and/or maintain a selected one of said first and second positions; and
f) dampening means comprising a layer of viscoelastic material, elastically deformable to absorb energy from the armature as it contacts the first member and to substantially regain its original dimensions once the deforming force has been removed.

53. A valve as claimed in claim 52, wherein the viscoelastic material is protected from damage due to repeated impact by a layer of a harder plastic with which it is overlaid.

54. A valve as claimed in claim 53, wherein the harder plastic is a polyetheretherketone (PEEK).

55. A valve as claimed in claim 52 wherein the valve closure comprises a valve seal provided on the armature and wherein during the first actuations of the valve, the valve seal assumes a permanent deformation or set, and, as the valve seal assumes this set, the dampening means is progressively deformed.

56. A valve as claimed in claim 52 wherein the armature is pivotably mounted at one end such the pivoted end is substantially in contact with the first member and the valve closure end can move between the first position and the second position in an arcuate path such that the impact between the armature and the first member progresses along an angle creating both normal and shear stresses in the dampening means.

57. A valve as claimed in claim 52 wherein the dampening means is attached to, and moves with, the armature and impacts the first member before the armature reaches the end of its stroke.

58. A valve as claimed in claim 52 wherein the dampening means is attached to the first member and is deformed by the armature as it approaches the end of its stroke.

59. A valve as claimed in claim 52 wherein the valve further comprises an enclosure containing the armature and in which the second port is located so as to be open in the first and second positions of the armature, wherein: the first member comprises a leg extending laterally from an end piece and ending in a magnetic pole.

60. A valve as claimed in claim 59, wherein the valve further comprises a second leg extending laterally from the end piece, the second leg being of a non-magnetic material.

61. A valve as claimed in claim 59, wherein the first fluid flow port is located in the magnetic pole; the armature and first member forming a magnetic circuit and the coil surrounding a part of the magnetic circuit; the arrangement being such that when a higher fluid pressure prevails at the first port than at the second port, the fluid flow maintains the armature in its first position with the valve closure separated from the first port such that the fluid may flow from the first port to the second port via the enclosure, and when a higher fluid pressure is applied to the second port than the first port the armature will be caused by the fluid to assume its second position with the valve closure closing the first port and checking the fluid flow through the enclosure and when the armature is in its second position and a current is applied to the coil the armature will move from its second position to its first position, thereby overriding the closed position of the valve.

62. A valve as claimed in claim 60, wherein the first fluid flow port is located in the magnetic pole; the armature and first member forming a magnetic circuit and the coil surrounding a part of the magnetic circuit; the arrangement being such that when a higher fluid pressure prevails at the first port than at the second port, the fluid flow maintains the armature in its first position with the valve closure separated from the first port such that the fluid may flow from the first port to the second port via the enclosure, and when a higher fluid pressure is applied to the second port than the first port the armature will be caused by the fluid to assume its second position with the valve closure closing the first port and checking the fluid flow through the enclosure and when the armature is in its second position and a current is applied to the coil the armature will move from its second position to its first position, thereby overriding the closed position of the valve.

63. A valve as claimed in claim 62, wherein a non magnetic-surface is provided at the end of the second leg, opposite the magnetic pole, forming a stop which restricts the motion of the armature in the direction away from the magnetic pole.

64. A valve as claimed in claim 60, wherein the first fluid flow port is provided within pole shaped end of the second leg.

65. A valve as claimed in claim 59, wherein the enclosure containing the armature is in part defined by the end piece, the end piece being made up of at least two pieces, namely, a central piece in part defining the enclosure and a spacer placed between the central piece and the leg of the first member.

66. A valve as claimed in claim 65, wherein the central piece and the spacer are made of a magnetic material.

67. A valve as claimed in claim 65, wherein the enclosure containing the armature is made of the end piece which is constructed of a magnetic material and a second piece made of a non-magnetic material and a hole is provided in the second piece of the enclosure through which the pole piece of the magnetic leg protrudes enabling the co-operation of the armature with the pole piece.

68. A valve as claimed in claim 67, wherein the second, non-magnetic leg protrudes through a hole in the second piece of the enclosure enabling a symmetric construction and so facilitating its manufacture.

69. A valve as claimed in claim 67, wherein the second piece of the enclosure forms a bobbin on which the coil is wound and the armature passes longitudinally through the coil, separated therefrom by the bobbin.

70. A valve as claimed in claim 59, wherein the first fluid port is provided in the magnetic pole and the second fluid port is provided in the enclosure, the first fluid flow port being the inlet and normally fluid flows into that port and out of the second fluid flow port, which acts as the outlet.

71. A valve as claimed in claim 60, wherein the first fluid port is provided in the enclosure or the second, non magnetic leg opposite the magnetic pole and the second fluid flow port is provided in the enclosure, most preferably generally at an angle to the first fluid flow port.

72. A valve as claimed in claim 59, wherein the valve further comprises a second leg extending laterally from the end piece, the second leg being of a magnetic material and the valve comprises permanent magnetic means to provide a north and a south permanent magnetic pole at the ends of each of the first and second magnetic legs, the first fluid flow port being provided in the first magnetic leg, and the armature being movable between a first stable position adjacent the magnetic pole of the first magnetic leg thereby blocking the first fluid flow port therein and a second stable position adjacent to the magnetic pole of the second magnetic leg whereby the first fluid flow port is unblocked, the other end of the armature being substantially adjacent a midpoint of the magnetic means, thus providing a circuit between the armature, the magnetic pole which it is adjacent and the part of the magnetic means between the magnetic pole and the other end of the armature; and the coil surrounding said armature such that when energised with a pulse of electricity the armature is caused to move from one stable position to its other stable position.

73. A valve as claimed in claim 72, wherein the end piece is a permanent magnet and forms the permanent magnetic means.

74. A valve as claimed in claim 73, wherein the end piece comprises three pieces, one central piece forming part of the enclosure and being made of a soft magnetic material and two spacers comprising permanent magnets either side of the central piece, between the central piece and the magnetic legs.

75. A valve as claimed in claim 74, wherein one or both spacers are wedge shaped whereby a spacer may be inserted between the central piece and the first or second leg to a varying degree to substantially fill the gap therebetween and so as to effect the desired spacing therebetween, so as to be able to accommodate tolerances in the spacing between the said leg and the central piece.

76. A valve as claimed in claim 59, wherein the valve has three ports, one in each of the legs and the third in the enclosure and being permanently open.

77. A valve as claimed in claim 55, wherein the valve seal comprises resilient sealing means and protrudes from the armature and wherein abutment means are provided to limit movement of the armature as it moves towards the valve seat, thereby limiting the degree of compression of the resilient sealing means when engaged with the valve seat.

78. A valve as claimed in claim 77, wherein the valve seat comprises a raised lip extending from the second surface, the sealing edge of the raised lip is recessed from the first surface.

79. A valve as claimed in claim 52, wherein the first member is substantially U shaped and the armature is positioned such that it can assume one of two positions where it either bridges the space between the two ends of the first member such that both ends of the armature are substantially in contact with the first member, or in which both ends of the armature are apart from the first member.
